(19) United States
(12) Patent Application Publication
(10) Pub. No.: US 2021/0151202 A1
(43) Pub. Date: May 20, 2021

(54) Automated CO2 offsetting in real-time.

(71) Applicants: Karim Jabbar, Copenhagen (DK); Rachid Jabbar, Copnehagen (DK)

(72) Inventors: Karim Jabbar, Copenhagen (DK); Rachid Jabbar, Copnehagen (DK)

(21) Appl. No.: 16/953,382

(22) Filed: Nov. 20, 2020

Related U.S. Application Data
(60) Provisional application No. 62/937,818, filed on Nov. 20, 2019.

(51) Int. Cl. G16Y 20/30; G16Y 20/10; G16Y 40/10

(52) U.S. Cl. CPC G16Y 20/30; G16Y 40/10; G16Y 20/10

(57) ABSTRACT

The present invention discloses innovative aspects that can be embodied in methods that include CO2 offsetting in short term intervals that range from daily, hourly, and all the way down to offsetting by the second. These offsetting methods take place through renewable energy installations in single or multiple locations globally. These installations can be owned and operated by individuals or deployed in various geographies by leasing companies, decentralized utilities, or similar set-ups. The carbon offsets generated, issued, sold, and retired through these methods include live production data from a variety of IoT devices, such as, but not limited to, smart meters, converters, inverters, and monitoring systems, as well as payment and ERP systems. Another innovative aspect of the present invention includes methods for software application plug-ins that interface with one or several embodiments of the system. These methods enable the automated offsetting in real-time of particular CO2 emission behaviors of consumers that relate to domains such as, but not limited to, (i) building automation, (ii) transport and mobility (air, land and sea), (iii) retail, and (iv) banking and payment services. Furthermore, another innovative aspect of the present invention includes the methods for importing pre-issued carbon offset credits from third-party carbon registries, and issuing, blending and selling these credits though the automation and real-time features of various embodiments of the present method. The carbon offsets, or other digital energy attributions, created through the methods presented in the present invention can be automatically retired on purchase, and can therefore not be double issued, or double spent.

This application claims priority under 35 USC § 119 (e) to U.S. Patent Application Ser. No. 62/937,818, filed on Nov. 20, 2019, the entire contents of which are hereby incorporated by reference.

### TECHNICAL FIELD

The present invention relates to the technical field of carbon offsetting and Blockchain technology hereunder Distributed Ledger Technology. More particularly, the invention relates to a Blockchain or Distributed Ledger Technology-based system for automatically generating, issuing, selling and retiring carbon offsets from renewable energy sources in real-time.

### BACKGROUND

Carbon offsetting refers to the action or process of compensating for carbon dioxide emissions arising from industrial or other human activity, by participating in schemes designed to make equivalent reductions of carbon dioxide in the atmosphere. The standard metric in carbon offsetting is ton of CO2 equivalent (tCO2e).

Carbon offsetting can be done though two distinct mechanisms embodied in two broadly defined markets: (i) The compliance market, such as the EU Emissions Trading Scheme (ETS), which is based on an allowance logic. This is also referred to as a cap-and-trade market. Here compensation happens through trading allowances allocated or auctioned out by regulators. Entities having exceeded their cap, will through this scheme be obliged to compensate by purchasing a similar amount of allowances from entities having emitted a lower amount of CO2e than allowed by their cap. (ii) the voluntary market, on the other hand is unregulated, and based on a project logic. Here compensation happens by investing in projects that have mitigated an equivalent amount of CO2e as the entity wishing to offset has emitted. While these markets are co-existing, trading across them is allowed under certain conditions, such as for instance through so called Internationally Tradeable Mitigation Outcomes (ITMOs), as prescribed by the Paris Agreement.

Carbon offsetting projects generally fall under two broad categories: (i) Carbon sink projects, which simply put refer to anything that absorbs and stores more carbon from the atmosphere than it releases as carbon dioxide. The most widespread carbon sink projects are forestry projects such as REDD+ projects. (ii) Renewable energy projects, which are based on the deployment of renewable energy resources that are naturally replenished on a human timescale, such as sunlight, wind, rain, tides, waves, and geothermal heat. Deploying renewable energy assets is seen as a replacement for the energy otherwise available locally, such as the energy mix of the electrical grid, or the burning of diesel and kerosene in off-grid locations. Deploying renewable energy assets can therefore be seen as mitigating the CO2 emissions caused by the current energy infrastructure.

While there is no formal requirement to this effect, most carbon offsetting projects are verified by third parties, who through their activities assess the validity of the project in question. This is done by certifying that the offsets generated by the project are: real, verified, permanent, and additional.

The third parties verifying carbon offsetting projects issue the particular carbon offsets to each project according to specific methodologies, and store these offsets on their respective registries. In order to make an offsetting claim, the purchasing entity needs to retire the particular carbon offsets in the registry of the verifying body, so that it cannot be double-spent. In the voluntary markets there are as many registries as certifying bodies. Projects not verified by one of these bodies, furthermore have to keep their own registry to ensure the proper retirement of offsets.

The first implementation of Blockchain was Bitcoin, which was introduced by an anonymous person or group under the name Satoshi Nakamoto in the early aftermath of the financial crisis. The agenda of Bitcoin, was to disintermediate financial institutions and to introduce a system for peer-to-peer transaction of digital cash (Nakamoto, 2008). It aimed at creating a computational system through which globally distributed peers (users) would be able to transact a native digital currency freely and instantaneously across the world in a trusted manner, while ensuring that double spending of units of this currency is impossible. Validation of the monetary transactions, and settlement between accounts on the system would happen through a codified consensus mechanism that would remove the need for a trusted third party such as a bank, or clearing house. Blockchain systems modelling the original implementation can be modified in order to cover a large variety of other types of transaction data that go beyond cryptocurrency.

Today, Blockchain is an umbrella term for IT systems with wide areas of application that combine elements of (i) a replicated and shared distributed ledger, (ii) cryptographically secure transactions, and (iii) consensus algorithms for validation of these transactions. The transaction data stored on these distributed ledgers is generally bundled in blocks that are validated at specific time intervals and chained to previous blocks through a string of cryptographic hashes, thus the name Blockchain. Some more recent systems have all the above characteristics, but do not store the transaction data in chains of blocks. These are referred to as Distributed Ledger Systems (DLTs) but are generally considered part of the broader Blockchain category since they share the same underlying principles.

### SUMMARY

In general, one innovative aspect of the subject matter described in this specification can be embodied in methods that include CO2 offsetting in short term intervals that range from daily, hourly, and all the way down to offsetting by the second. These offsetting methods take place through renewable energy installations in single or multiple locations globally. The carbon offsets generated, issued, sold, and retired through these methods include live production data from a variety of IoT devices, such as, but not limited to, smart meters, converters, inverters, and monitoring systems. Through the methods, the production data gets combined with carbon intensity data, not limited to standardized, real-time or marginal, as well as time-stamped, and geo-tagged. This results in digital carbon offsets, or other digital energy attributions, that are kept in a registry run on a Distributed Ledger System or a Blockchain. These carbon offsets, or other digital energy attributions, can be automatically retired on purchase, and can therefore not be double issued, or double spent.

In general, another innovative aspect of the subject matter described in the specification includes methods for software application plug-ins that interface with one or several embodiments of the system. These methods enable the automated offsetting of particular CO2 emission behaviors of consumers that relate to domains such as, but not limited to, (i) building automation, (ii) transport and mobility, (iii) air travel, (iv) retail, and (v) banking and payment services.

Particular embodiments of the subject matter described in this specification can be implemented to realize one or more of the following advantages. Renewable energy installations can monetize the sustainability attributes, such as, but not limited to CO2 mitigation value, of the electricity they produce by connecting their production data to one of the embodiments of the methods described in this specification. Distributed utilities, that own and lend out, lease, or otherwise manage a multitude of distributed renewable energy assets across geographical space, will be enabled to monetize the sustainability attributes generated by these assets as if they were collocated. Small-scale renewable energy installations will be able to spread out the issuing of carbon offsets into minute denominations (e.g. grams of CO2e, rather than tons of CO2e), which will allow them a steadier revenue flow. The consumers wishing to offset their carbon emissions though an embodiment of the methods for software application plug-ins covered by the subject matter of this specification, will have access to an offset product of high granularity. This could imply, a blended product comprised of small-scale offsets from multiple installations, or offsets customizable by source of origin. All the offsets will be traceable back to the specific various installations that contributed to their generation. The embodiments of the methods for software application plug-ins will allow for seamless and automated carbon offsetting in real-time of for instance, but not limited to, (i) electricity consumption in buildings, (ii) miles driven in automotive vehicles (whether powered by fossil fuels, hydrogen, hybrid, or electricity, or other sources), (iii) miles flown by airlines (commercial or otherwise), (iv) emissions generated on board ships, be they commercial or otherwise, and (v) products purchased (physical or services).

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

For a proper understanding of the examples described herein, reference should be made to the enclosed figures. It should be appreciated that the figures depict only some embodiments and are not limiting of the scope of the present disclosure.

FIG. 1 illustrates the entire architecture of a Blockchain or Distributed Ledger Technology-based system for automatically generating, issuing, selling and retiring carbon offsets from renewable energy sources in real-time, wherein imports from other carbon registries are also enabled.

FIG. 2 illustrates various methods and associated systems-connections for generating energy production input that will be the basis for calculating the mitigation value of the carbon offsets.

FIG. 3 illustrates examples of embodiments of the system, which extract data from massively distributed renewable energy installations that are managed by a central production or payment data server.

FIG. 4 illustrates instances, in which a Building Automation Application Plug-in, can automatically create purchase orders for carbon offsets, based on data conversion algorithms, that are subsequently settled on the ledger/registry of a DLT or a Blockchain.

FIG. 5 illustrates instances, in which Mobility Application Plug-ins, can automatically create purchase orders for carbon offsets, based on data conversion algorithms, that are subsequently settled on the ledger/registry of a DLT or a Blockchain. Similar logic will apply for embodiments offsetting the emissions of ships, commercial and otherwise.

FIG. 6 illustrates instances, in which a Flight Application Plug-in, can automatically create purchase orders for carbon offsets, based on data conversion algorithms, that are subsequently settled on the ledger/registry of a DLT or a Blockchain.

FIG. 7 illustrates instances, in which Payment and Banking Application Plug-ins, can automatically create purchase orders for carbon offsets, based on data conversion algorithms, that are subsequently settled on the ledger/registry of a DLT or a Blockchain.

FIG. 8 illustrates an example end-to-end process performed using an embodiment of a Blockchain or Distributed Ledger Technology-based system for automatically generating, issuing, selling and retiring carbon offsets from renewable energy sources in real-time.

FIG. 9 illustrates examples of embodiments of the system, which import data from other carbon registries, wherein the data is composed of carbon offset credits that are already issued, verified, and/or certified by established third-party verification and certification schemes

### DETAILED DESCRIPTION

In order to explain the objects, technical solutions and advantages of the present invention more apparently, the present invention is further described in detail below with reference to the specific embodiments and accompanying drawings. It should be understood that these descriptions are merely exemplary and are not intended to limit the scope of the present invention. In addition, in the following description, descriptions of well—known structures and techniques are omitted to avoid unnecessarily obscuring the concepts of the present invention.

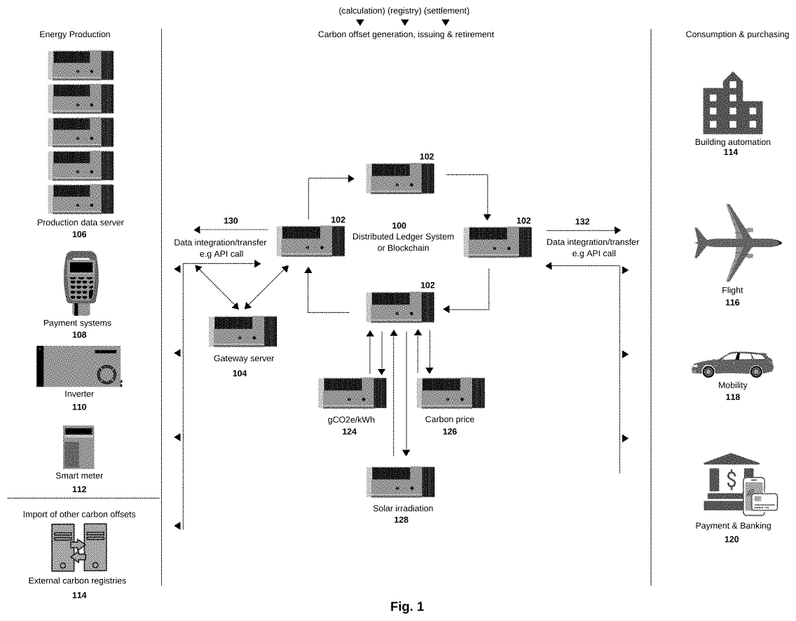

FIG. 1 illustrates the overall architecture of a system based on the methods constituting the present invention. The core of the system (100) is constituted of a Distributed Ledger Technology system (DLT), or a Blockchain, made up of numerous independent but connected computer nodes (102). The Distributed Ledger or Blockchain gets data input from one or a plurality of either a production data server (106), a payment solution (108), an inverter (110), a smart meter (112), or a third-party verified/certified carbon registry (114) though a data integration/transfer, for example, but not limited to, a GET or a POST API call (130). The data is either sent directly to the Distributed Ledger, or Blockchain, or alternatively it can be gathered on a gateway server (104) prior to being mirrored onto the DLT or Blockchain (100). The data collected from these data integrations, transfers, or APIs will be converted via mathematical algorithms to carbon mitigation values in very small increments all the way down to the gram of CO2e. Each data reading is then locked-in as a micro-scale carbon offset that will be purchased by clients on the demand side through real-time software application plug-ins. On the consumption and purchasing side of the system (the demand side), several embodiments of the methods representing the present invention will include interfaces with the DLT or Blockchain through data integration, transfer, or APIs in the area of building automation (114), flight (116), mobility including automotive and ships (118), as well as payment and banking (120). These software application plug-ins allow for seamless and automated offsetting in real-time.

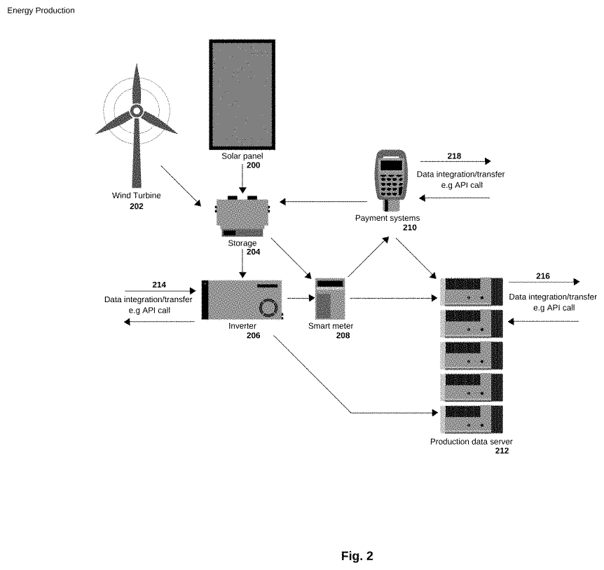

FIG. 2 illustrates various methods in which energy production data from renewable energy sources can be transferred to the DLT or Blockchain system that is at the core of the embodiments of the present invention. As illustrated, depending on the embodiment of the present invention, the data can either be received through data integration, transfer, or via GET or POST API call to/from the storage system, or by other comparable means of data transfer (204), the inverter (206), the smart meter (208), the payment systems that processes the access to the renewable energy installations (218), or through a production data server (216) operated by the individual installation owner or a company managing the deployment of multiple installations in various geographies. For each of the data collection methods, there will be a specific mathematical algorithm that converts the data received from its original unit of measurement to “CO2 emission reductions” expressed in grams of CO2e. In some instances, this conversion will be similar, in others it will draw on very different conversion metrics.

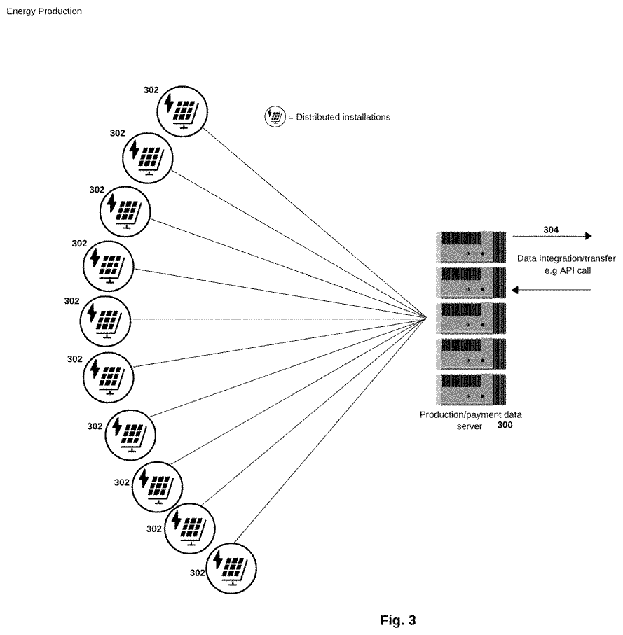

FIG. 3 illustrates an embodiment of the methods that make up the present invention, in which the energy production data transferred (304) to the DLT/Blockchain originates from massively distributed installations (302) operated by one centralized entity (300). Examples of this include, but are not limited to, distributed utilities operating on a pay-as-you-go (PAYG) scheme, leasing companies deploying multiple installations in various geographies, or other similar set-ups.

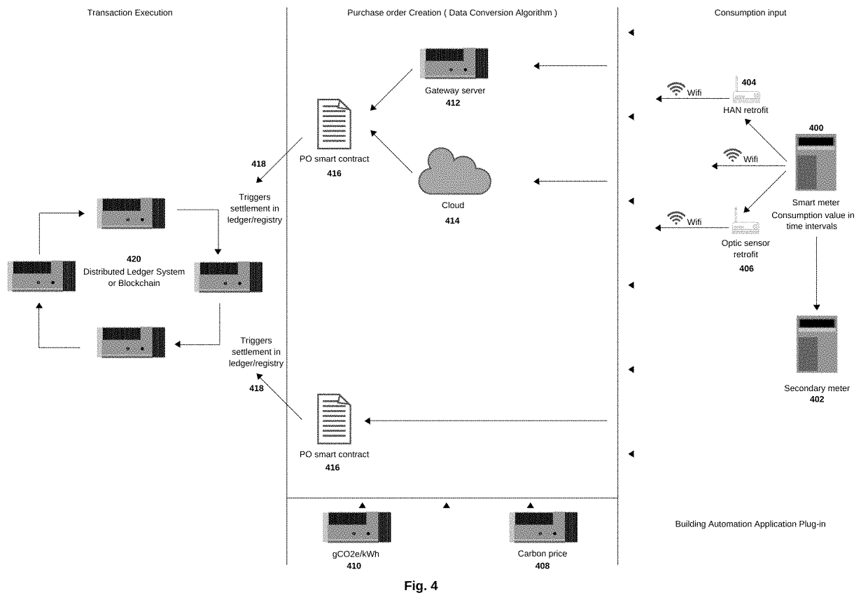

FIG. 4 illustrates an embodiment of a method for capturing electricity consumption input from buildings, converting the reading to a CO2 emissions value, and creating a purchase order to be executed and settled on the DLT/Blockchain that is at the core of the method for automatically offsetting carbon emissions in real-time. More specifically, the electricity consumption input can be captured from an analogue meter, a smart meter (400), or a secondary meter (402). From the smart meter the data can either be captured directly from an embedded device, through a home area network retrofit—HAN—(404), or through an optic sensor retrofit (406). The captured data is then transferred via WiFi or other transmission protocol to either a cloud service (414), a gateway server (412), or straight to a smart contract (416) on the DLT/Blockchain. Here the data is combined with a carbon intensity value (410) fetched from a different database, as well as a daily carbon price taken from the EU ETS spot market (408). Collectively, this data makes up a time sequence of purchase orders denominated in grams of CO2e to be offset automatically through the micro carbon offsets generated by renewable energy installations in developing countries as generally described in paragraph [0023]. The transactions taking place will thus be settled through triggers (418), and stored on the DLT/Blockchain (420).

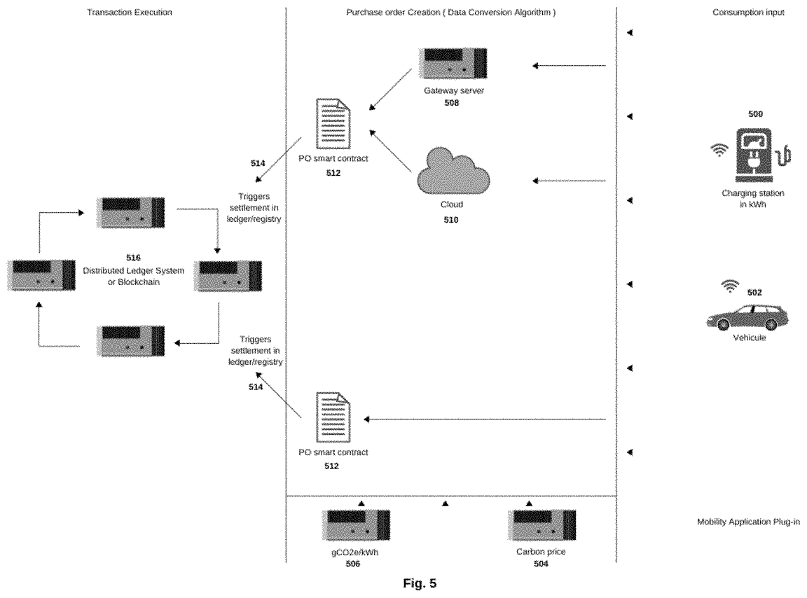

FIG. 5 illustrates an embodiment of a method for capturing emissions data from vehicles, and electricity consumption data from EV charging stations. When needed, i.e., if the metrics are different, the reading of the data gets converted to a CO2 emissions value, which is then used for creating a purchase order to be executed and settled on the DLT/Blockchain that is at the core of the method for automatically offsetting carbon emissions in real-time. More specifically, the electricity consumption input can be captured from an EV charging station (500), or from the vehicle itself (502), as a kWh measurement, or more directly as a CO2e reading if the vehicle runs on fossil fuel. The captured data is then transferred via WiFi or other transmission protocol to either a cloud service (510), a gateway server (508), or straight to a smart contract (512) on the DLT/Blockchain. Here the data is combined with a carbon intensity value (506) fetched from a different database, as well as a daily carbon price taken from the EU ETS spot market (504). Collectively, this data makes up a time sequence of purchase orders denominated in grams of CO2e to be offset automatically through the micro carbon offsets generated by renewable energy installations in developing countries as generally described in paragraph [0023]. The transactions taking place will thus be settled through triggers (514), and stored on the DLT/Blockchain (516).

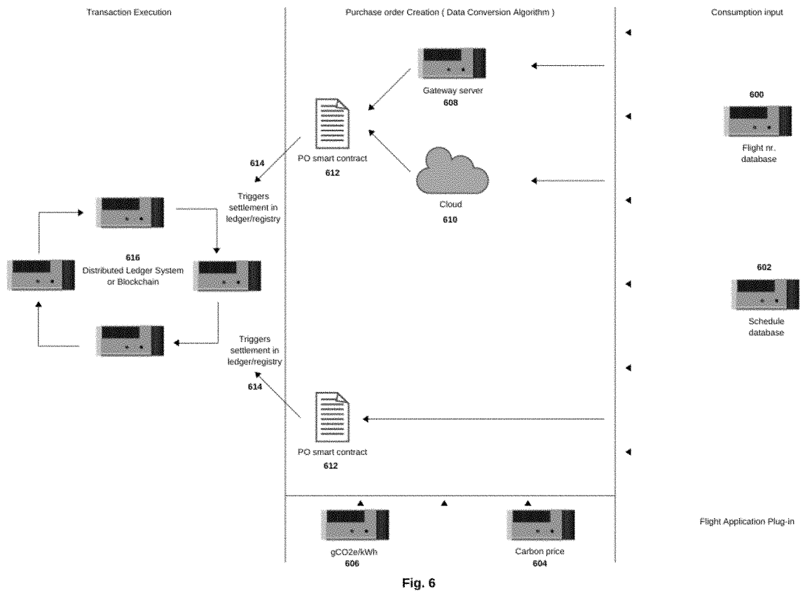

FIG. 6 illustrates an embodiment of a method for capturing CO2 emissions data from airlines in real-time. The CO2 emissions value, generated in small time intervals through this method, is used for creating purchase orders to be executed and settled on the DLT/Blockchain that is at the core of the method for automatically offsetting carbon emissions in real-time. More specifically, the general flight data, such as departure and arrival times, altitude, speed, and so on, are captured from databases such as a flight number database (600) or a schedule database (602). The captured data is then transferred via WiFi or other transmission protocol to either a cloud service (610), a gateway server (608), or straight to a smart contract (612) on the DLT/Blockchain. Here the data is combined with a carbon intensity value (606) expressed in grams of CO2 emitted by passenger mile flown. This carbon intensity value is fetched from the database of the airline in question, or comparative databases ranking airlines' flight efficiency. The data is furthermore combined with a daily carbon price taken from the EU ETS spot market (604). Collectively, this data makes up a time sequence of purchase orders denominated in grams of CO2e to be offset automatically through the micro carbon offsets generated by renewable energy installations in developing countries as generally described in paragraph [0023]. The transactions taking place will thus be settled through triggers (614), and stored on the DLT/Blockchain (616).

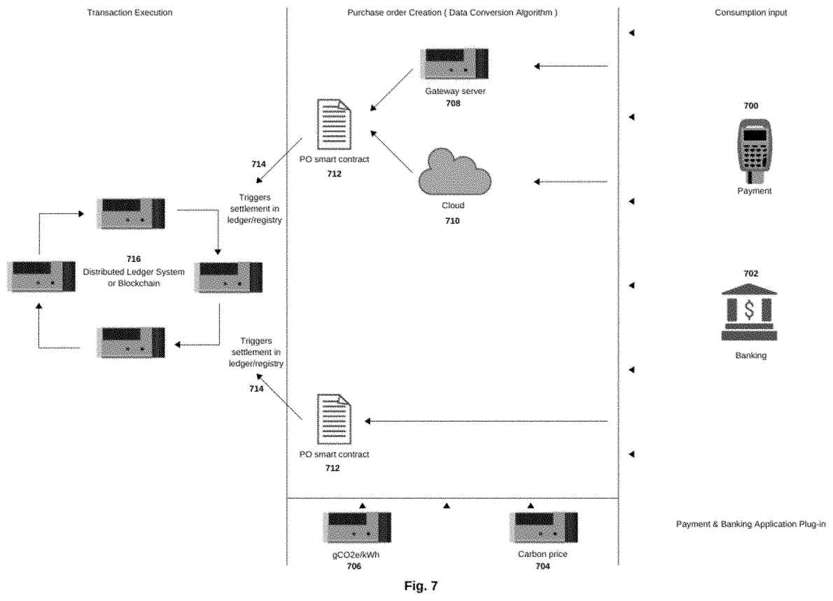

FIG. 7 illustrates an embodiment of a method for capturing CO2 emissions data from purchases of products and services. The CO2 emissions value, generated in intervals linked to specific payments, is used for creating purchase orders to be executed and settled on the DLT/Blockchain that is at the core of the method for automatically offsetting carbon emissions in real-time. More specifically, payment data is fetched from point of sales systems (700) or from an open banking platform (702) that is either run by the bank itself, or by fintech companies offering this service to customers. The captured data is then transferred via WiFi or other transmission protocol to either a cloud service (710), a gateway server (708), or straight to a smart contract (712) on the DLT/Blockchain. Here the data is combined with a carbon intensity value (706) expressed in grams of CO2 emitted by product/service purchase category. This can be at high level of granularity, or all the way down to SKU-number level. The data is furthermore combined with a daily carbon price taken from the EU ETS spot market (704). Collectively, this data makes up a time sequence of purchase orders denominated in grams of CO2e to be offset automatically through the micro carbon offsets generated by renewable energy installations in developing countries as generally described in paragraph [0023]. The transactions taking place will thus be settled through triggers (714), and stored on the DLT/Blockchain (716).

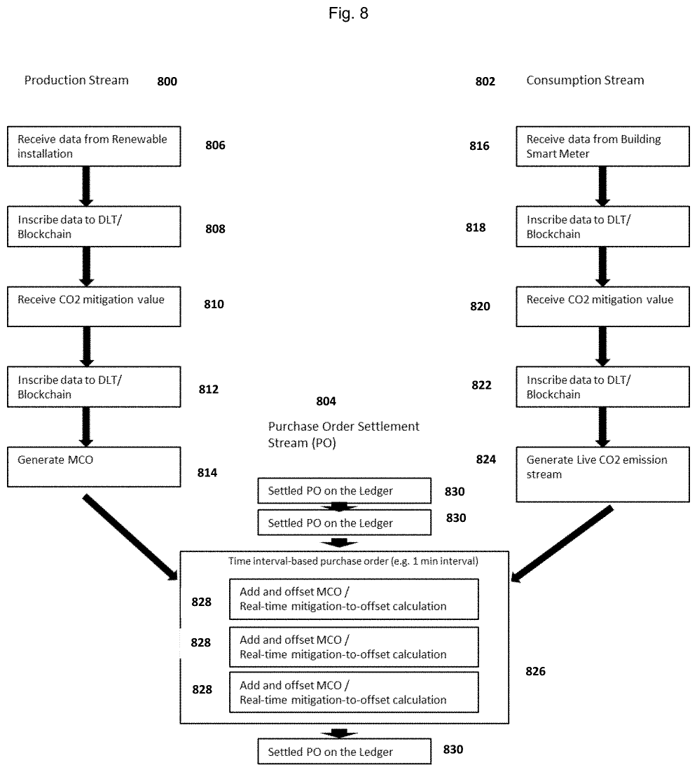

FIG. 8 illustrates three interconnected process streams, for a given embodiment of the methods highlighted in this disclosure, which result in the settlement of purchase orders, and their storing on a DLT/Blockchain. More specifically this embodiment is based on a production stream (800), a consumption stream (802) and a purchase order settlement stream (804). The production stream results in the generation of Micro Carbon Offsets (MCOs) (814), while the consumption stream results in the generation of a live CO2 emission stream (824). Based on the live CO2 emission stream (824), purchase orders are created in small time intervals (826). In this particular embodiment the time interval is one minute. Within this minute, the generated MCOs (814) are added to the purchase order in chronological sequence. The MCO then gets offset in real-time. This specifically means that the mitigation value contained in the MCO gets absorbed by the purchase order on a second-by-second basis (828). This is what the illustration refers to as “real-time mitigation-to-offsetting calculation”. Once depleted, the next MCO in the ledger gets added to the purchase order, and the same operation is performed once more. At the end of the purchase order time interval (one minute in this embodiment), the settled MCO gets stored on the DLT/Blockchain (830) where they become visible in the “history functionality” of the purchasing entity.

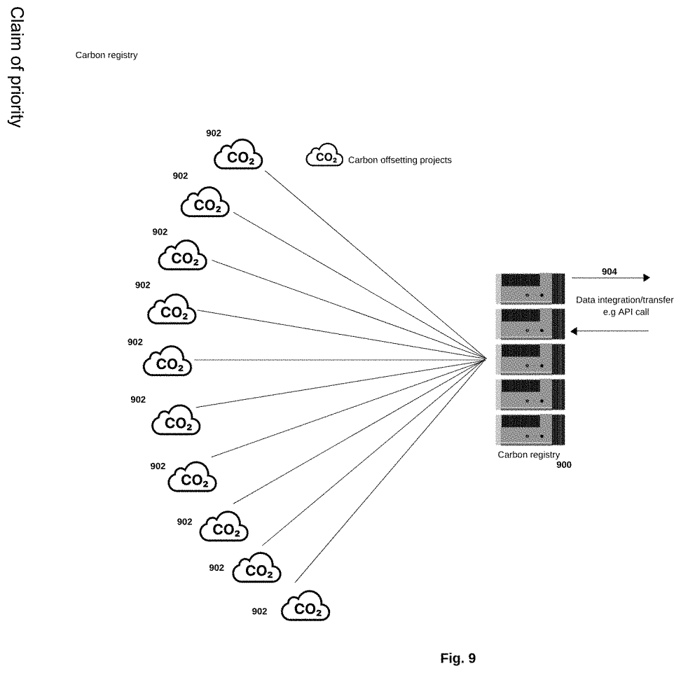

FIG. 9 illustrates an embodiment of the method that make up the present invention, in which data representing pre-issued carbon offsets is transferred (904) to the DLT/Blockchain from carbon offsetting projects (902) that have been verified or certified, and issued onto a registry by an established carbon verification/certification body (300). Examples of this include, but are not limited to, third-party standard setting organizations that operate carbon registries onto which they issue the carbon offset credits associated with renewable energy projects or carbon capture/sequestration projects that they themselves have verified/certified, or that other accredited organizations have verified/certified on their behalf.

One having ordinary skill in the art will readily understand that the above may be practiced with steps in a different order, and/or with hardware elements in configurations that are different than those which are disclosed. Therefore, although the application has been described based upon these preferred embodiments, it would be apparent to those of skill in the art that certain modifications, variations, and alternative constructions would be apparent.

What is claimed is:

1. A computer-implemented method for automatically offsetting CO2 emissions in real-time, comprising:
Generating carbon offsets from collocated as well as geographically distributed renewable energy installations, by capturing data from a plurality of IoT devices, and databases, calculating the CO2 emission reduction associated with said data, and issuing digital representations of this data (carbon offsets) that embody the associated CO2 emission reductions;
Storing said digital representations of the captured and, through calculations, modified data in a Distributed Ledger (DLT), or a Blockchain, where they are made available for purchasing by entities wishing to offset their CO2 emissions;
Selling said digital representations through software application plug-ins, relying on a plurality of IoT devices and databases, which generate and settle a time-based sequence of purchase orders allowing for automated and real-time offsetting of CO2 emissions;
Automatically retiring said digital representations from the ledger/registry, when they are purchased by entities wishing to offset their CO2 emissions.

2. A computing system comprising:
a storage configured to store a plurality of digital representations of CO2 emission reductions in a Distributed Ledger System (DLT) or a Blockchain, each stored digital representation quantifying (metrically or otherwise) the CO2 emissions reductions associated with particular data transfers received from a plurality of collocated or distributed renewable energy installations;
wherein the storage is also configured to store data imports from other registries of carbon offsets, which can get stored on said Distributed Ledger System (DLT) or Blockchain as digital representations of the carbon offset credits in question, hereunder other renewable energy projects or carbon sequestration/capture projects;
a network interface configured to receive a plurality of data readings from the software systems supporting the monitoring of collocated and geographically distributed renewable energy installations, the systems including live monitoring via IoT devices, payment systems, and otherwise;
wherein the network interface is further configured to receive a plurality of data aimed at augmenting the data readings from the above-mentioned renewable energy installations, hereunder but not limited to national, regional or site-specific carbon intensity data, carbon pricing data, as well as location data; and
wherein the network interface is also configured to receive automated triggers for purchasing carbon offsets from a plurality of software application plug-ins, which get settled in time-based intervals or in real-time;
a processor configured to execute computational algorithms transforming the data received through the network interface into a quantifiable CO2 emission reduction output associated with said data,
wherein the processor is further configured to issue digital representations of this data (carbon offsets) that embody the CO2 emission reductions associated with each of the plurality of data transfers received, and
wherein the processor is also configured to automatically retiring said digital representations from the ledger/registry, when they are purchased by entities wishing to offset their CO2 emissions.

3. The computing system according to claim 2, wherein the applied Distributed Ledger System (DLT) or Blockchain is a technological solution developed by a third-party, including but not limited to proprietary, as well as open source systems in all their embodiments.
